(19) United States
(12) Patent Application Publication
(10) Pub. No.: US 2002/0188842 A1
(43) Pub. Date: Dec. 12, 2002

(54) Client system validation by network address and associated geographic location verification

(76) Inventor: Tandy G. Willeby, Dallas, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 09/874,261

(22) Filed: Jun. 6, 2001

(51) Int. Cl. H04L 9/00

(52) U.S. Cl. 713/154; 705/73

(57) ABSTRACT

A system, method, and computer program product which allows a server system to verify the geographic location of a client system in order to authenticate the user or authorize a transactions. The server system, in the preferred embodiment, uses the client system's network address to determine a corresponding geographic location. In an alternative embodiment, the client system is equipped with a geographic positioning system which precisely determines the geographic location of the client system, and reports this location to the server system. The preferred embodiment is particularly drawn to a secure system, method, and computer program product for authorizing an automated teller machine (ATM) application running on a data processing system.

### TECHNICAL FIELD

The present application relates to a system, method, and computer program product for authenticating a user or authorizing a transaction based on the geographic location of the user or client system.

### DESCRIPTION OF THE RELATED ART

Personal accounts have become an omnipresent aspect of contemporary society, associated with almost every aspect of our lives. Personal accounts are associated with, for example, telephone calling cards, checking and savings accounts in banks, computer networks, and credit cards. Typically, account security is maintained (and unauthorized access prevented) by use of a password or personal identification number (PIN).

Account security is maintained by requiring two separate steps for account access. First, the account number must be entered. Second, a password or PIN associated with the account must be entered as well. The account number is typically not concealed (i.e., it may be printed on the telephone calling card or credit card, or it may be recorded on a magnetic strip affixed to the card which is read by an associated card reader) and may be considered, at least for security purposes, to be readily accessible. In contrast, a password or PIN is not supposed to be readily accessible. Rather, a user is typically instructed to memorize and not write down a password or personal identification number to prevent inadvertent disclosure of the password or PIN. By keeping the password or PIN confidential, unauthorized access to an account is hopefully prevented.

Additionally, in many applications, it may be desirable to limit access based on the location of the user. For example, because the laws between states often differ, a legal activity for a user in one state may be illegal in another state. Further, it may be desirable to use the location of the user as a means of validating his identity.

Linking an IP Address with a geographical location has been of interest for quite some time. One early attempt to design a system that actually routes packets according to their geographic destination is “Cartesian Routing” by Gregory G. Finn (see G. Finn, Routing and Addressing Problems in Large Metropolitan-scale Internetworks, ISI Research Report ISI/RR-87-180, University of Southern California, March 1987, which is hereby incorporated by reference. See also “Geographic Addressing, Routing, and Resource Discovery with the Global Positioning System”, Tomasz Imielinski and Julio C. Navas, Rutgers, The State University in Piscataway, N.J. 08855, 1996, which is hereby incorporated by reference.

The recent redesign of the Internet Protocol (IP) and the advent of the Global Positioning System have given a new stimulus for this work. In the proposed redesign of IP, IP address type space was specifically allocated for geographic addresses. IP addresses would be assigned to subnets and hosts based on topological criteria, such as geography. In this protocol, the sender of a “geographic message” would be unicasting messages only to such hosts which have geographic addresses. The methods in this paper attempt to provide the more general ability of sending a message to all recipients within a geographical area, regardless of whether or not the hosts have geographical addresses.

It would therefore be desirable to provide an additional means of authenticating a user and the user's access privileges according to the user's geographic location.

### SUMMARY OF THE INVENTION

It is therefore one object of the present invention to provide an improved system, method, and computer program product for receiving passcodes through a graphical user interface.

The foregoing objects are achieved as is now described. The preferred embodiment provides a system, method, and computer program product which allows a server system to verify the geographic location of a client system in order to authenticate the user or authorize a transactions. The server system, in the preferred embodiment, uses the client system's network address to determine a corresponding geographic location. In an alternative embodiment, the client system is equipped with a geographic positioning system which precisely determines the geographic location of the client system, and reports this location to the server system. The preferred embodiment is particularly drawn to a secure system, method, and computer program product for authorizing an automated teller machine (ATM) application running on a data processing system.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIG. 1 depicts a block diagram of a data processing system in accordance with a preferred embodiment of the present invention;

FIG. 2 shows a block diagram of several systems connected to the internet, in accordance with a preferred embodiment of the present invention; and

FIG. 3 depicts a flowchart of a process in accordance with a preferred embodiment of the present invention.

### DETAILED DESCRIPTION OF THE PREFERRED EMBODIMENTS

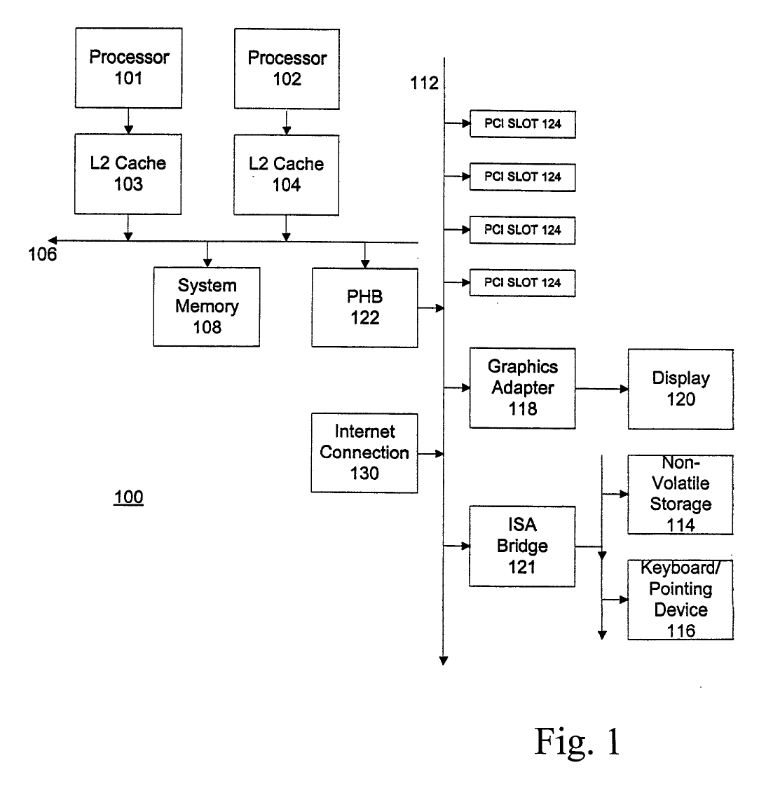

The numerous innovative teachings of the present application will be described with particular reference to the presently preferred embodiment (by way of example, and not of limitation). With reference now to the figures, and in particular with reference to FIG. 1, a block diagram of a data processing system in which a preferred embodiment of the present invention may be implemented is depicted. Data processing system 100 includes processors 101 and 102, which in the exemplary embodiment are each connected to level two (L2) caches 103 and 104, respectively, which are connected in turn to a system bus 106.

Also connected to system bus 106 is system memory 108 and Primary Host Bridge (PHB) 122. PHB 122 couples I/O bus 112 to system bus 106, relaying and/or transforming data transactions from one bus to the other. In the exemplary embodiment, data processing system 100 includes graphics adapter 118 connected to I/O bus 112, receiving user interface information for display 120. Peripheral devices such as nonvolatile storage 114, which may be a hard disk drive, and keyboard/pointing device 116, which may include a conventional mouse, a trackball, or the like, are connected via an Industry Standard Architecture (ISA) bridge 121 to I/O bus 112. PHB 122 is also connected to PCI slots 124 via I/O bus 112.

Also connected to I/O bus 112 is internet connection 130. This connection can be implemented in any number of ways, including an analog modem, a cable modem, xDSL, T1, a wireless device, and others.

The system can optionally include a geographic positioning system (GPS) receiver 132, connected to the I/O bus 112. This receiver can be implemented in any number of devices, as long as the device is capable of determining its geographic location and making this location available to data processing system 100.

The exemplary embodiment shown in FIG. 1 is provided solely for the purposes of explaining the invention and those skilled in the art will recognize that numerous variations are possible, both in form and function. For instance, data processing system 100 might also include a compact disk read-only memory (CD-ROM) or digital video disk (DVD) drive, a sound card and audio speakers, and numerous other optional components. All such variations are believed to be within the spirit and scope of the present invention. Data processing system 100 and the exemplary figures below are provided solely as examples for the purposes of explanation and are not intended to imply architectural limitations. In fact, this method and system can be easily adapted for use on any programmable computer system, or network of systems, on which software applications can be executed. A data processing system as described above can function both as a client system and a server system in the embodiments described below, when connected to a computer network such as an intranet or the Internet. Of course, the data processing systems described below, and in particular the client data processing system, may be implemented in a mobile telephone, a handheld system such as a personal digital assistant, or other portable or handheld data processing system, as long as it can perform the claimed functions.

The preferred embodiment provides a system, method, and computer program product which allows a server system to verify the geographic location of a client system in order to authenticate the user or authorize a transactions. The server system, in the preferred embodiment, uses the client system's network address to determine a corresponding geographic location. In an alternative embodiment, the client system is equipped with a geographic positioning system which precisely determines the geographic location of the client system, and reports this location to the server system. The preferred embodiment is particularly drawn to a secure system, method, and computer program product for authorizing an automated teller machine (ATM) application running on a data processing system.

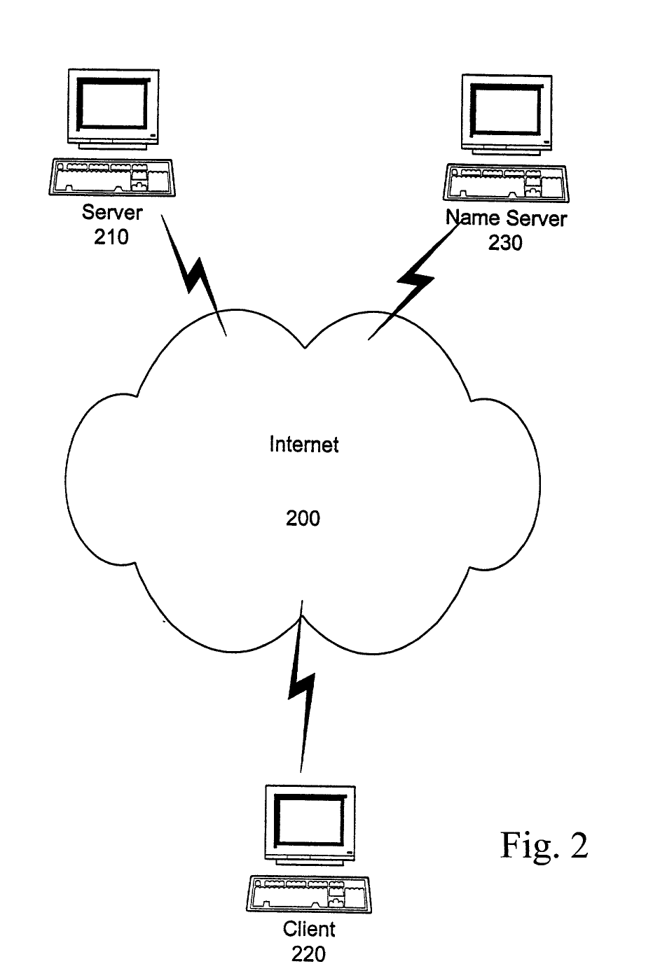

FIG. 2 shows a diagram of several data processing systems connected to the Internet 200. Here, server system 210 and client system 220 are each connected to the internet 200 to communicate with each other and with other Internet-connected systems. Further, name server system 230 is connected to the internet 200 to communication with other internet-connected systems, such as server system 210 and client system 220.

Name server system 230 is a server system that translates alphanumeric internet addresses, into universal internet network addresses, as is conventional. Name server system 230 also keeps a database of physical addresses associated with the internet addresses. By associating physical, geographic addresses with internet addresses, the name server system 230 can track the physical location of client systems according to the internet addresses of those systems.

Of course, this database does not necessarily reside on a separate name-server system, but can be incorporated into the server system 210, for faster, local lookups.

According to the preferred embodiment, when the user of the client system 220 attempts to access a resource on server system 210, the server system will attempt to authenticate the user of client system 220. The server system 210 may use any conventional way of doing so, such as a username/password combination. The server system 210 will then further authenticate the user by verifying the user's location. This is done by extracting the client system's 220 network address, and looking this address up on the name server system 230 to determine the corresponding physical address of that client system 220. The server system 210 will then permit or deny the client system 220 access to the resource, depending on where the client system is located.

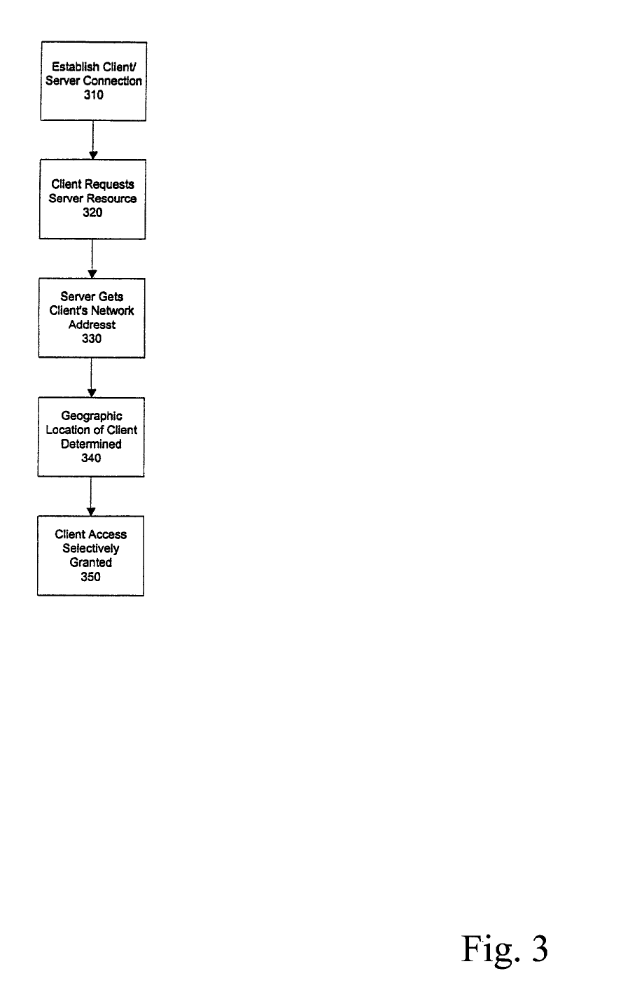

FIG. 3 shows a flowchart of a process in accordance with a preferred embodiment of the present invention. First, a connection is established between the client system and the server system (step 310). Next, the client system requests a resource from the server system (step 320). The server system will then read the network address of the client system (step 330). The server system will find the physical location that corresponds to the network address (step 340). The server system will then approve or deny the client system access to the server resource, depending on where the client system is located (step 350).

Of course, any other validation system can also be used in conjunction with the geographic validation system, before, after, or as the geographic validation is taking place. The increased security of the geographic validation can be particularly advantageous for cash-transfer systems, as the transactions can be limited to systems in particular geographic areas.

The disclosed method is particularly useful for internet transactions which enjoy a different legal status depending on the location of the user. For example, an on-line gambling system may be legal for participants in one state, but may be illegal for participants in another state. Because internet gaming is not technologically limited to one geographic area, the preferred embodiment provides a means for the gaming host to ensure that the only gamers are those that can do so legally.

In an alternative embodiment, the client system is equipped with hardware, such as a Global Positioning System receiver, which reports the precise geographic location of the

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

While the invention has been particularly shown and described with reference to a preferred embodiment, it will be understood by those skilled in the art that various changes in form and detail may be made therein without departing from the spirit and scope of the invention. For example, the server and client systems described above can be any data processing system connected to communication with another system. The client system can be implemented in any number of data processing system devices, including desktop and laptop computers, mobile telephones, personal digital assistants (PDAs) and other devices, as well as in conventional ATM or telephone systems.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

It is important to note that while the present invention has been described in the context of a fully functional data processing system and/or network, those skilled in the art will appreciate that the mechanism of the present invention is capable of being distributed in the form of a computer usable medium of instructions in a variety of forms, and that the present invention applies equally regardless of the particular type of signal bearing medium used to actually carry out the distribution. Examples of computer usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

What is claimed is:

1. A method for validating a user, comprising the steps of:
receiving, in a server system, a request for a server resource from a client system;
determining a network address of the client system;
determining a geographic location corresponding to the network address; and
permitting or denying access to the server resource according to the geographic location.

2. The method of claim 1, wherein the network address is an IP address.

3. The method of claim 1, wherein the geographic location is determined from a name-server entry corresponding to the network address of the client system.

4. The method of claim 1, wherein the geographic location is determined from a global positioning system receiver on the client system.

5. The method of claim 1, wherein the server resource includes an automatic-teller application.

6. The method of claim 1, wherein the server resource includes an on-line gambling application.

7. The method of claim 1, further comprising the step of receiving a passcode from the client system.

8. A method accessing a remote server, comprising the steps of:
requesting, in a client system, access to a server resource on a server system;
sending a network address of the client system to the server system;
sending a passcode to the server system; and
selectively receiving access to the server resource depending on the passcode and a geographic location corresponding to the network address.

9. The method of claim 8, wherein the server resource is an automatic-teller application.

10. The method of claim 8, wherein the server resource is an on-line gambling application.

11. A computer program in a computer-readable medium, comprising:
instructions for receiving, in a server system, a request for a server resource from a client system;
instructions for determining a network address of the client system;
instructions for determining a geographic location corresponding to the network address; and
instructions for permitting or denying access to the server resource according to the geographic location.

12. The computer program product of claim 11, wherein the network address is an IP address.

13. The computer program product of claim 11, wherein the geographic location is determined from a name-server entry corresponding to the network address of the client system.

14. The computer program product of claim 11, wherein the geographic location is determined from a global positioning system receiver on the client system.

15. The computer program product of claim 11, wherein the server resource includes an automatic-teller application.

16. The computer program product of claim 11, wherein the server resource includes an on-line gambling application.

17. The computer program product of claim 11, further comprising instructions for receiving a passcode from the client system.

18. A computer program in a computer-readable medium, comprising:
instructions for requesting, in a client system, access to a server resource on a server system;
instructions for sending a network address of the client system to the server system;
instructions for sending a passcode to the server system; and
instructions for selectively receiving access to the server resource depending on the passcode and a geographic location corresponding to the network address.

19. The computer program product of claim 18, wherein the server resource is an automatic-teller application.

20. The computer program product of claim 18, wherein the server resource is an on-line gambling application.
